(19) United States
(12) Patent Application Publication
(10) Pub. No.: US 2026/0229203 A1
(43) Pub. Date: Aug. 6, 2026

(54) Self-Centering Intonation Thumbscrew for Stringed Musical Instruments

(71) Applicant: Justin Richard Bruen, Bellvue, CO (US)

(72) Inventor: Justin Richard Bruen, Bellvue, CO (US)

(21) Appl. No.: 19/046,968

(22) Filed: Feb. 6, 2025

(51) Int. Cl. G10D 3/14; G10D 3/04

(52) U.S. Cl. CPC G10D 3/14; G10D 3/04

(57) ABSTRACT

The self-centering intonation thumbscrew for stringed musical instruments passes through the bridge plate intonation screw hole and threads into the string-saddle, common on many stringed instruments like electric guitar and bass. The tension of the string on the string-saddle pulls the conical tapered collar of the intonation screw into the bridge intonation screw hole; the conical tapered collar of the invention stabilizes the screw in the center of the hole, preventing unwanted movement during playing or adjustment that can alter the pitch of the string. The knurled and slotted head of the intonation screw allows the player to adjust intonation and fine-tuning of a string by using a guitar pick, a screwdriver, or fingers only.

### BACKGROUND OF THE INVENTION

### 1. Field of the Invention

The Self-Centering Intonation Thumbscrew for Stringed Musical Instruments is relevant to the field of stringed musical instruments that use common bent-steel or block-style bridge string-saddles common on many stringed instruments like electric guitar and bass to adjust intonation and action of the string. In particular, it keeps the intonation adjustment screw centered in the intonation screw hole in the bridge plate, which stabilizes pitch and provides multiple ways for a player to adjust the intonation and fine-tuning of a string by using fingers or a tool like a slotted screwdriver or a guitar pick. The self-centering feature, in combination with tool-free adjustment, cannot be achieved by the previous art and improves tuning stability and convenience of intonation and fine-tuning adjustments.

### 2. Discussion of the Prior Art

In the previous art, the intonation adjustment of a stringed instrument string-saddle is achieved by turning a screw passing through the intonation screw hole in the bridge plate. These screws are usually panhead screws that require a screwdriver to adjust. US Patent US 20120234154 A1 claims a thumbscrew with a smooth mating surface on the side that comes into contact with the flat surface of the bridge plate. The contact between the two smooth flat surfaces of the screw and the bridge plate does not prevent the threaded stem of the intonation screw from wiggling side-to-side or up and down within the bridge plate intonation screw hole, which is slightly larger than the screw to allow for height adjustment of the string-saddle without binding. This intonation screw movement can cause the string-saddle to shift slightly, which can compromise the tuning stability of the string.

With the Self-Centering Intonation Thumbscrew for Stringed Musical Instruments, tension from the string pulls on the string-saddle, which in turn pulls the conical tapered collar of the intonation screw into the bridge plate intonation screw hole, which stabilizes the intonation screw in the center of the bridge intonation screw hole.

### BRIEF SUMMARY OF THE INVENTION

The Self-Centering Intonation Thumbscrew for Stringed Musical Instruments uses a conical tapered collar extending from the knurled head of the thumb screw down to the threads to automatically center the intonation screw in the intonation adjustment screw hole in the bridge plate as string tension is applied to the string-saddle. The conical tapered section of the thumbscrew seats into the intonation screw hole of the bridge plate and prevents the screw from moving up and down or side-to-side causing the bridge string-saddle to shift positions and alter the pitch of the string. The knurled surface of the thumbscrew allows the player to adjust intonation and fine tuning of the pitch of a string by hand without requiring tools. The thumbscrew head can also include straight slots on the top that can facilitate adjustment with a guitar pick or screwdriver.

### BRIEF DESCRIPTION OF THE SEVERAL VIEWS OF THE DRAWINGS

FIG. 1 is a side view of the invention.

FIG. 2 is a top view of the invention showing the slot that a flathead screwdriver or guitar pick can fit into to turn the screw.

FIG. 3 is a bottom view of the invention.

FIG. 4 is a cross sectional side view of a common bridge and string-saddle assembly showing how the invention self-centers in the bridge plate intonation adjustment screw hole.

### DETAILED DESCRIPTION OF THE PREFERRED EMBODIMENT

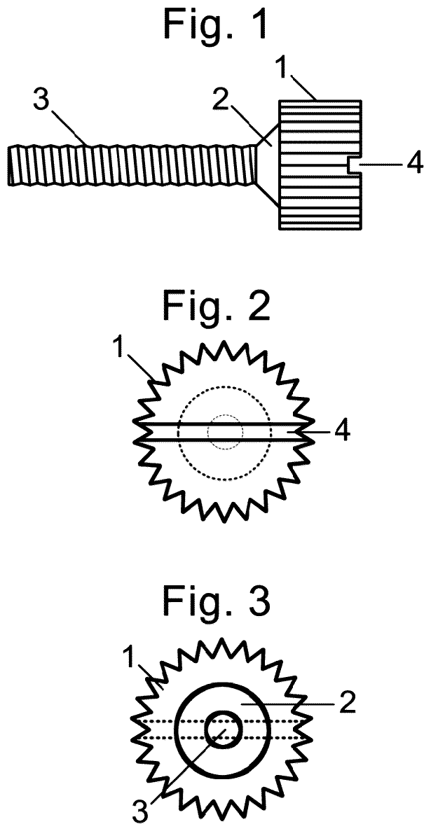

FIG. 1 is a side view of the invention showing the knurled head (1) for adjusting with fingers, the conical tapered collar (2) for centering the screw into the bridge plate intonation screw hole, the threaded stem (3) that threads into the string-saddle, and the slot (4) for a guitar pick or screwdriver to fit into to make adjustments.

FIG. 2 is a top view of the invention showing the knurled head (1) for adjusting with fingers, and the slot (4) for a guitar pick or screwdriver to fit into.

FIG. 3 is a bottom view of the invention showing the knurled head (1) for adjusting with fingers, the tapered conical collar (2) for centering the screw into the bridge plate intonation screw hole, and the threaded stem (3) that threads into the string-saddle.

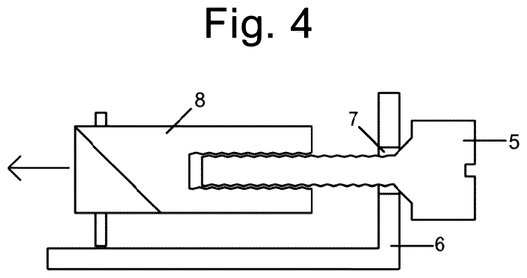

FIG. 4 is a cross sectional view of the invention (5), passing through the bridge intonation screw hole (7) of the bridge plate (6) and threaded into the string-saddle (8) which is pulled by the tension of the string in the direction of the arrow. The string-saddle (8) pulls the conical tapered collar of the invention (5) into the bridge plate intonation screw hole (7). The persistent string tension on the invention (5) keeps the conical tapered collar centered in the bridge intonation screw hole (7) even when it is being adjusted.

1. A self-centering Intonation thumbscrew for stringed musical Instruments comprising: a knurled head with a straight slot on the top and a conical collar tapering down from the knurled head to the threaded stem of the screw.
